(19) United States
(12) Patent Application Publication
(10) Pub. No.: US 2025/0218416 A1
(43) Pub. Date: Jul. 3, 2025

(54) Convertible Stringed Instrument Pick

(71) Applicant: Ronald P. Manginell, Albuquerque, NM (US)

(72) Inventor: Ronald P. Manginell, Albuquerque, NM (US)

(21) Appl. No.: 18/883,643

(22) Filed: Sep. 12, 2024

Related U.S. Application Data
(60) Provisional application No. 63/617,413, filed on Jan. 3, 2024.

(51) Int. Cl. G10D 3/173

(52) U.S. Cl. CPC G10D 3/173

(57) ABSTRACT

Embodiments of the present invention provide an apparatus comprising three important elements: (1) a “finger attachment element” that securely attaches to a digit (also referred to herein as a finger) of the user's hand and is configured to connect to a coupler element, described below; (2) a “pick attachment element” that connects to a commercial off the shelf (COTS) plectrum/pick, preferably in a manner not requiring permanent modifications to realize this invention, configured to connect to the coupler element, described below; (3) a “coupler element” that connects to both the pick attachment element and the finger attachment element and facilitates transitions of the pick between the modes of playing, such as through built-in friction. Various finger attachment element embodiments are contemplated including as examples a ring, a flexible plastic or metal ring, an elastic sleeve, a spring-mounted ring, a hook and loop band, and a ratcheting ring.

### TECHNICAL FIELD

The present invention is directed to the field of aids for plucking strings of musical instruments, and more specifically to a pick-holding apparatus configured to facilitate transitions between various methods of playing a stringed musical instrument, and to such an apparatus integrated with a pick.

### BACKGROUND ART

This disclosure relates to a device that allows an instrumentalist to easily modulate between “fingerpicking” and “flat picking” modes, though it does not preclude “hybrid” picking or “thumbpicking” either. Instruments to which this invention relates include, but are not limited to guitars, bass guitars, mandolins, banjos, and ukuleles. For the sake of discussion, right-handed playing of a guitar is used as an example henceforth, though this description applies to all instruments that can be plucked. Note: right-handed guitarists will typically pluck the strings with their right hand; left-handed guitars usually pluck the strings with their left hand instead. This invention conforms to both types of handedness and playing styles by simple mirroring of the designs shown in the figures and photos.

Typically, guitarists fall into three categories based on the way they pluck or sound the strings: flat-picking, fingerpicking or hybrid. In fingerpicking, the guitarist plucks the guitar strings with right hand digits. This can be accomplished with the pads of the fingers, natural fingernails, false fingernails, or finger-attached fingerpicks, many examples of which are commercially available. Classical and Spanish/Flamenco guitarists are noted for playing fingerstyle and many examples can be found online, for example on YouTube, by musicians such as David Russell and Paco de Lucia; these two players demonstrate right-handed fingerstyle technique. Advantages of this style are the ability to easily sound chords on multiple, adjacent or non-adjacent strings, the ability to play complicated arpeggios with facility, and to play both the melody and harmony simultaneously. One potential difficulty for many players is the ability to play single-note lines rapidly with this method, or to play as loudly as a flat pick. For reference, fingerpickers often refer to the digits as p=thumb, i=index, m=middle, a=annularis (ring finger) and c=chiquito (pinky finger).

Flat picking technique utilizes a flat pick or plectrum, most often positioned between the thumb and forefinger. This technique is commonly used and offers for instance great volume control, relative ease of learning, and speed in single-line phrases and ease of strumming chords as well. There are countless examples of flat picking on YouTube, and Tony Rice and Steve Vai are exemplary in this regard. Complicated arpeggios and chords on non-adjacent strings are more challenging with flat picking as compared with fingerpicking.

Hybrid picking is a compromise between these. Typically, a flat pick is positioned as usual and the m and a fingers are used in fingerpicking. This provides some of the benefits of flat picking and some of the benefits of fingerpicking, but is nonetheless a compromise. This method impedes the full facility of fingerpicking and often players feel the need to set down the pick, put it between their teeth or lips, or reposition it in their hands (between other fingers or in the palm of their hand), which all impede fingerpicking. Danny Gatton is exemplary in his use of hybrid picking techniques, as can be observed on YouTube.

Chet Atkins is a noted player that uses a thumbpick. In a way, this is a variation on hybrid picking, or might be considered another school of technique. In this method, a special pick is used that is attached directly to the thumb or p digit. Thumb picks are a compromise on the traditional flat pick and many players find them awkward, without the versatility of flat picks and difficult to use in a traditional finger picking style. Finally, Steve Vai and Eddie Van Halen exemplify a technique known as right-hand tapping, and the present invention also facilitates that technique when combined with flat picking by holding the pick out of the way while right-hand tapping is utilized.

Atkin U.S. Pat. No. 6,797,871B2 offers both a flat picking position and a retracted position for use in finger style playing. Unlike the present invention, however, Atkin has the following substantial disadvantages: the inability to fully retract the pick for true fingerstyle technique where the thumbnail (or fleshy part of the thumb) is used for sounding the string; the method of attachment requires permanent modification of the plectrum for attachment; neither the wedge for angle-of-attack adjustment nor the velcro attachment of claim 18 are adaptable real-time (while playing the instrument) or solely with the picking hand; FIGS. 18-19 show pick modifications that make use of commercial off the shelf picks impractical.

Kikvadze GB2300063A and Sogabe US20040237754A1 do not allow for use of commercial off the shelf picks, in contrast with the present invention. Sielaf US20060086231A1 is useful for strumming and picking with the finger digits, but prohibits natural fingerstyle thumb use of the nail or flesh of the thumb; moreover, there is no method to reposition the pick. Beall, U.S. Pat. No. 4,497,237, does not offer a method to reposition a pick from flat picking mode to fingerstyle mode with the picking hand, nor does it offer a means to lock the pick in either position. U.S. Pat. No. 5,837,913, issued to Newman, and U.S. Pat. No. 6,977,330 of Santa Cruz use a long-tether to attach a pick to the middle digit, the dangling nature of which would interfere directly with fingerpicking. U.S. Pat. No. 4,497,237, issued to Beall, unlike the presentation invention, rotates the pick about the index finger, placing the pick in direct interference with the natural motion of the thumb in fingerpicking.

### DISCLOSURE OF INVENTION

Embodiments of the present invention provide an apparatus comprising three important elements: (1) a “finger attachment element” that securely attaches to a digit (also referred to herein as a finger) of the user's hand and is configured to connect to a coupler element, described below; (2) a “pick attachment element” that connects to a commercial off the shelf (COTS) plectrum/pick, preferably in a manner not requiring permanent modifications to realize this invention, configured to connect to the coupler element, described below; (3) a “coupler element” that connects to both the pick attachment element and the finger attachment element and facilitates transitions of the pick between the modes of playing, such as through built-in friction. Various finger attachment element embodiments are contemplated including as examples a ring, a flexible plastic or metal ring, an elastic sleeve, a spring-mounted ring, a hook and loop band, and a ratcheting ring.

Various pick attachment element embodiments that connect with a COTS plectrum or pick are contemplated. An example structure is an elastic or rubber sleeve which when stretched around the waist of a plectrum holds it securely without requiring permanent modifications to the pick. The elastic can be shaped like a wide band, or like the entire wide end of a plectrum as in an example embodiment. Another example structure is a non-permanent adhesive, or a pre-formed adhesive patch. In another example embodiment, a 3M (trademark of its owner) double sided adhesive tape was cut into a square shape (about 6 mm on a side, but this is not critical, nor is a square footprint—ovals, circles, etc. can also be used). This adhesive tape was used to attach to a COTS plectrum to the assembly without permanently modifying the pick. The pick attachment element can also comprise a magnetic coupling using suitable materials in the finger attachment element and in the pick attachment element.

A coupler element provides a coupling mechanism that allows the plectrum, once attached to the pick attachment element and thus to the overall assembly, to transition between positions via the use of the picking hand alone and to remain in the chosen playing mode until it is desired by the player to change. One example embodiment comprises a stubby cylindrically-shaped post (which can also be described as a pin or an axle) connected nominally perpendicularly to the planar plectrum face by various means. One method comprises a hole in a flexible pick attachment band, such as that mentioned above. Through this hole a post is inserted, nominally with its principal axis perpendicular to the pick face. The figures show the approximate dumbbell shape of such a post which allows it to be held by both the sleeve and by the assembly. Finally, in this example embodiment, the pick is rotated about the axis of the post using the picking hand digits to change from flat-, hybrid- or thumb-picking mode (Position 1) to fingerpicking modes (Position 2); as noted above, one may also play in right-hand tapping mode in this position. Friction built into this embodiment allows the plectrum to remain in the fingerpicking position (Position 2), though more complicated schemes like ratcheting features can be used. While in Position 2 it is important the plectrum is positioned not to interfere with natural fingerpicking technique. While in flat picking or hybrid picking mode (Position 1) the pick is held firmly between the digits as is typical, but there is also sufficient built-in friction to allow thumb-picking. In Position 1, it is important that the plectrum tip protrude sufficiently beyond the flesh of the hand to strike the string naturally.

The coupler element can also be configured to provide for multiple different attachment points, which can allow for customization of the apparatus to different sizes or geometries of players' hands, or customization of the apparatus for different playing styles or personal preferences of a player.

This invention contemplates other structures to allow repositioning of the plectrum, for example using a slot instead of the pivot design just mentioned. In this example, a slot is formed in the assembly and a post is forced through the slot laterally by a digit to move the pick from one mode to the other. Other embodiments employ levers or cams or other structures familiar to those in the art. Friction in the example embodiment can be sufficient to hold the plectrum in Position 2, but other methods can be used such as ratcheting mechanisms, friction plates, cams, etc., familiar to those in the art. Finally, more complicated structures that facilitate changing positions can be used, like gears, springs or levers to allow push-button transitions or even motorized options. An important aspect is the ability to change from Position 1 to Position 2 with the picking hand and maintain those positions without interfering with natural technique in either position.

### BRIEF DESCRIPTION OF DRAWINGS

FIG. 1 is a schematic illustration of three views of a portion of an example embodiment.

FIG. 2 is a schematic illustration of an example embodiment.

FIG. 3 is a schematic illustration of an example embodiment.

FIG. 4 is a schematic illustration of an example embodiment.

FIGS. 5-18 are schematic illustrations of example embodiments.

### MODES FOR CARRYING OUT THE INVENTION AND INDUSTRIAL APPLICABILITY

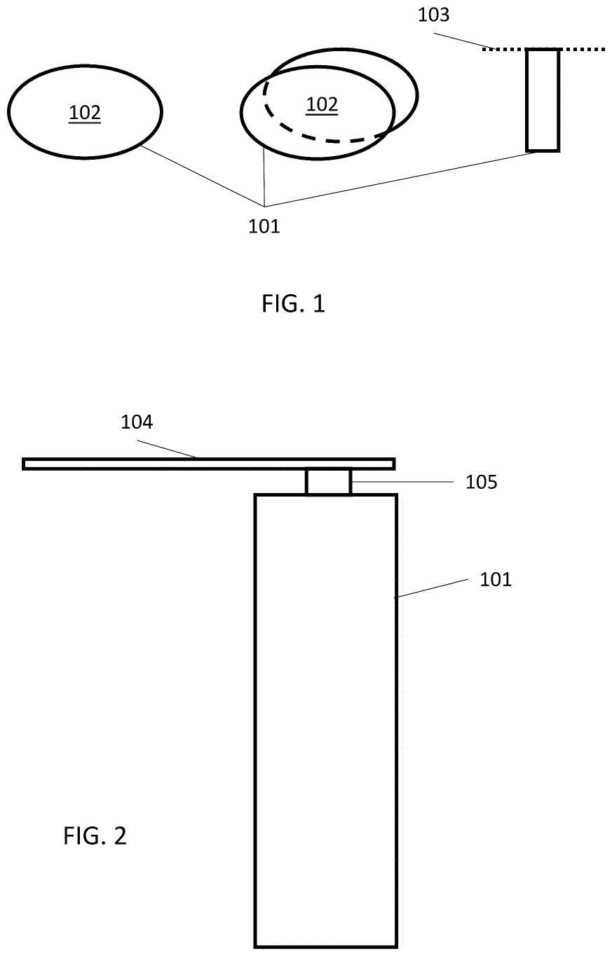

FIG. 1 is a schematic illustration of three views of a portion of an example embodiment. FIG. 1 shows a band-type finger attachment element 101 configured to be worn about a finger (where “finger” includes any of the digits of a human hand, including without limitation the thumb). A band can comprise various configurations and materials, as described below. The band 101 defines an interior space 102 suitable for a finger. The band 101 has an outer surface that defines a plane that is nominally tangential to the outer surface. The band can be configured to comfortably and securely mount with the finger, and to avoid unintended contact with the strings.

FIG. 2 is a schematic illustration of an example embodiment. A finger band 101 is configured to engage a finger of a user. A plectrum 104 mounts with the band 101 via a post 105. The plectrum 104 is rotatable about the axis of the post 105 between first (Position 1) and second (Position 2) positions.

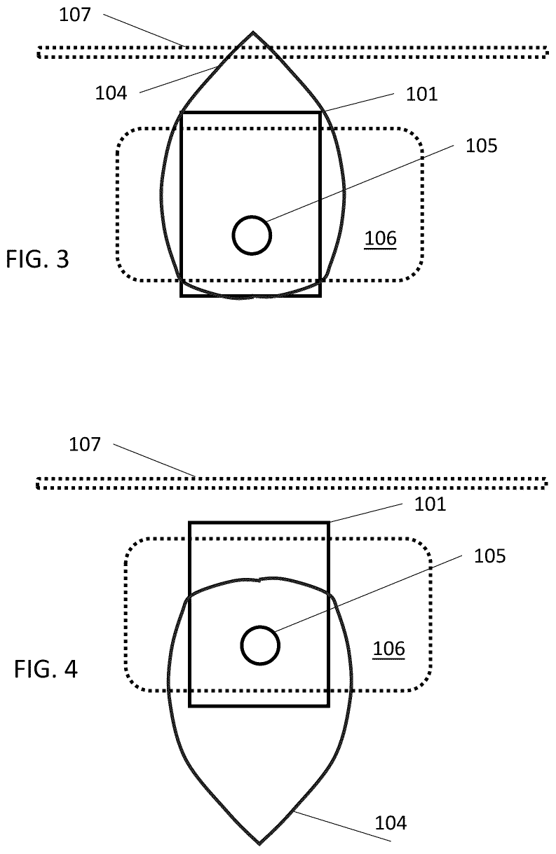

FIG. 3 is a schematic illustration of an example embodiment, with the plectrum 104 in the first position. A representation of a finger 106 and a representation of an instrument string 107 is shown. The plectrum 104 in the first position extends past the finger and the finger band, such that the plectrum can be used for plucking the string 107 of a stringed musical instrument.

FIG. 4 is a schematic illustration of an example embodiment, with the plectrum 104 in the second position, rotated about the axis of the post 105 relative to the configuration shown in FIG. 3. A representation of a finger 106 and a representation of an instrument string 107 is shown. The plectrum 104 in the second position no longer extends past the finger and the finger band to engage the string 107, such that the plectrum does not interfere with playing the instrument with a style other than using the plectrum.

Various finger band structures are contemplated. As examples: a flexible plastic ring adaptable to the shape of the human finger familiar to those in the art; a metal ring; a flexible or elastic sleeve; two curves interior surfaces attached on one edge by a spring to gently clamp the surfaces to the digit; mating hook-and-loop strips; two or more interior curved surfaces with ratcheting mating features to modify the closing force on the digit.

The invention can be implemented using suitable materials such as plastic, metals, carbon fiber, graphite, rubber or elastomer annulus, natural or synthetic fiber with hook-and-loop enclosures. For attaching to a COTS pick, a flexible elastomeric sleeve can be suitable, and also provides positional holding friction. Double sided adhesives cut in preforms like circles or rectangles can be suitable. Liquid or gel based adhesives can be suitable and there are many options that are reversible if desired. If the pick-holding mechanism is mechanical like a spring-plastic or spring steel clip, stiff plastic or metal can be used.

Commonly picks are made in small, medium and large sizes to accommodate different hand/finger sizes or playing preferences. Embodiments of the invention can accommodate a range of sizes, or can be dimensioned to work best with a particular pick size. E.g., an embodiment can provide three plastic ring sizes, and possibly three sizes of pick-holding structures.

The present invention has been described in connection with various example embodiments. It will be understood that the above description is merely illustrative of the applications of the principles of the present invention, the scope of which is to be determined by the claims viewed in light of the specification. Other variants and modifications of the invention will be apparent to those of skill in the art.

What is claimed is:

1. An apparatus to assist in playing a stringed musical instrument, comprising:
(a) a finger attachment element configured to both securely engage a finger of a user;
(b) a pick attachment element configured to retain a conventional plectrum;
(c) a coupler element that connects to the finger attachment element and the pick attachment element such that a plectrum retained in the pick attachment element is moveable by the user between a first playing mode and a second playing mode, and remains in a playing mode until action is performed by the user.

2. The apparatus of claim 1, wherein the finger attachment element comprises one or more of: a flexible plastic ring, a flexible metal ring, a flexible composite ring, an elastic sleeve, a spring-mounted ring, a hook and loop band, a ratcheting ring.

3. The apparatus of claim 1, wherein the pick attachment comprises one or more of: an elastic or rubber sleeve configured to stretch around a waist of the plectrum; an elastic or rubber sleeve configured to stretch around the entire grip-section of the plectrum; an adhesive between the plectrum and the coupler double-sided adhesive tape between the plectrum and the coupler; a spring-clamp of metal, plastic, composite, or similar material; a magnetic coupling between materials in the finger attachment element and the pick attachment element.

4. The apparatus of claim 1, wherein the coupler element comprises one or more of: a post connected to the finger attachment element and the pick attachment element with an axis roughly normal to the plane of the plectrum, wherein the plectrum rotates about the axis of the post; a post mounted with the finger attachment element extending into a slot formed in the assembly such that the plectrum is moveable by sliding the assembly along the direction defined by the interface of the post and the slot; a cam mounted with the finger attachment element and the assembly such that movement of the cam moves the plectrum.

5. The apparatus of claim 4, further comprising a spring, a lever, or a motor that acts to urge the assembly from a configuration where the plectrum is in the first playing mode and a configuration where the plectrum is in a second playing mode.

6. The apparatus of claim 1, wherein the assembly comprises a plectrum integrated into the assembly.

7. The apparatus of claim 1 wherein the coupler element is configured to provide multiple attachment points that accommodate adjustment to the size of a player's hand or playing preferences.

8. The apparatus of claim 1, wherein the finger attachment element comprises a ring.

9. The apparatus of claim 1, wherein the coupler and the pick attachment element are formed as a single piece.
